(19) United States
(12) Patent Application Publication
(10) Pub. No.: US 2002/0189226 A1
(43) Pub. Date: Dec. 19, 2002

(54) Pedestrian-operated power unit for detachable grass/ground treatment module

(76) Inventor: David Michel, Adel (GB)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/107,530

(22) Filed: Mar. 25, 2002

(30) Foreign Application Priority Data
Mar. 23, 2001 (GB) 0107353.3

(51) Int. Cl. A01D 34/53

(52) U.S. Cl. 56/249

(57) ABSTRACT

A pedestrian-operated power unit 10 for a detachable grass/ground treatment module 15 comprises a chassis 11, an engine 12 mounted on the chassis 11, a frame 13 extending upwardly from the chassis 11 to permit pedestrian control of the unit 10 via the frame 13, and an adaptor coupling 14 provided on the unit and adapted to permit releasable mounting thereon of a proprietary grass/ground treatment module 15 which is designed primarily for mounting on the frame of a multi-unit ride-on machine.

This invention relates to a pedestrian operated power unit for a detachable grass/ground treatment module.

In the past, manufacturers of grass/ground treatment machines, such as “greens” mowers, scarifiers, verticutters etc., have supplied a specific machine for each task. However, this has meant that customers, such as the owners of golfcourses, have had to buy and store a number of different machines, and this represents a substantial capital outlay, and relatively low utilisation of each machine.

Therefore, in recent years, there have been developed “universal” type of treatment machines, which comprise a power unit, and a support chassis which enables different types of treatment “module” to be mounted thereon.

In particular, heavy duty “ride-on” mowers are able to mount a number of separate modules e.g. cylindrical mower units, and a typical arrangement may comprise a set of three modules, having two modules arranged side by side with a small space defined between them, and a further module (in front of or behind the pair of modules) which is able to work on the grass/ground in the space between the pair of modules.

These modules are of substantial size and cost, and can be replaced by other modules when a different treatment is required i.e. a mower unit may be replaced by a scarifier or de-thatcher unit.

There are circumstances in which heavy duty machines cannot be used, and which include close cutting of a golf “green” for championship use, and also for cutting of golf greens when the ground is very wet and/or soggy. In either case, if the heavy duty machine were to be used, there would be undesirable application of excessive weight of the machine to the surface of the green via the ground wheels of the machine, and an unacceptable finish applied to the surface.

Therefore, there is a requirement to use a pedestrian type of machine for more delicate treatment, and up to now this has only generally been met by provision of a pedestrian machine having a treatment module which is specifically designed for the particular machine.

However, because the cutting height at which golf greens are mown is a matter of great importance to the playing characteristics of the putting surface, the height of cut of the cutting modules operated by the ride-on type of golf greens mowers will be painstakingly set to within a fraction of a millimeter, or sixty fourths of an inch. It would be a great benefit then for a golf green keeper to be able to simply detach one of his precisely set mowing modules from his greens triple mower (which he uses for routine mowing) and attach this same mowing module to a self-propelled pedestrian operated power unit, for use on occasions when a superior finish is required, or the ground is too wet to operate a heavy duty triple mower on.

The invention therefore seeks to provide a pedestrian-operated power unit, which can be purchased as a “universal” type of machine and which can readily be adapted to different treatment operations, by permitting proprietory and other treatment modules to be releasably coupled therewith, such modules being supplied as original/replacement equipment with ride-on machines.

According to the invention there is provided a pedestrian-operated power unit for a detachable grass/ground treatment module, and comprising:

a chassis;

an engine mounted on the chassis;

a frame extending upwardly from the chassis to permit pedestrian control of the operation of the unit via the frame; and

an adapter coupling provided on the unit and adapted to permit releasable mounting thereon of a grass/ground treatment module.

The invention therefore provides a power module which can be adapted for many different types of grass/ground treatment use, subject to detachable mounting thereon of any suitable treatment module of a type primarily supplied for use with a heavy duty “ride on” type machine.

A preferred embodiment of the invention will now be described in detail, by way of example only, with reference to the accompanying drawings, in which:

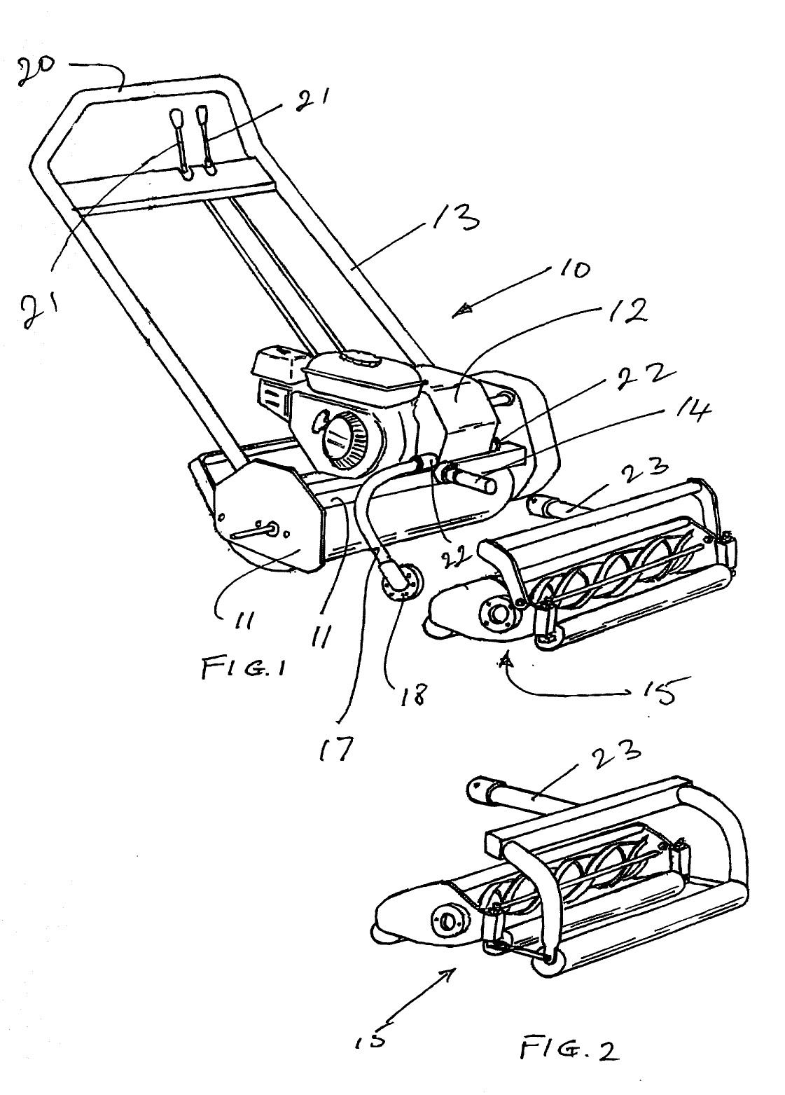

FIG. 1 is a perspective, exploded view of a pedestrian-operated power unit according to the invention, and a detachable grass treatment module for use therewith;

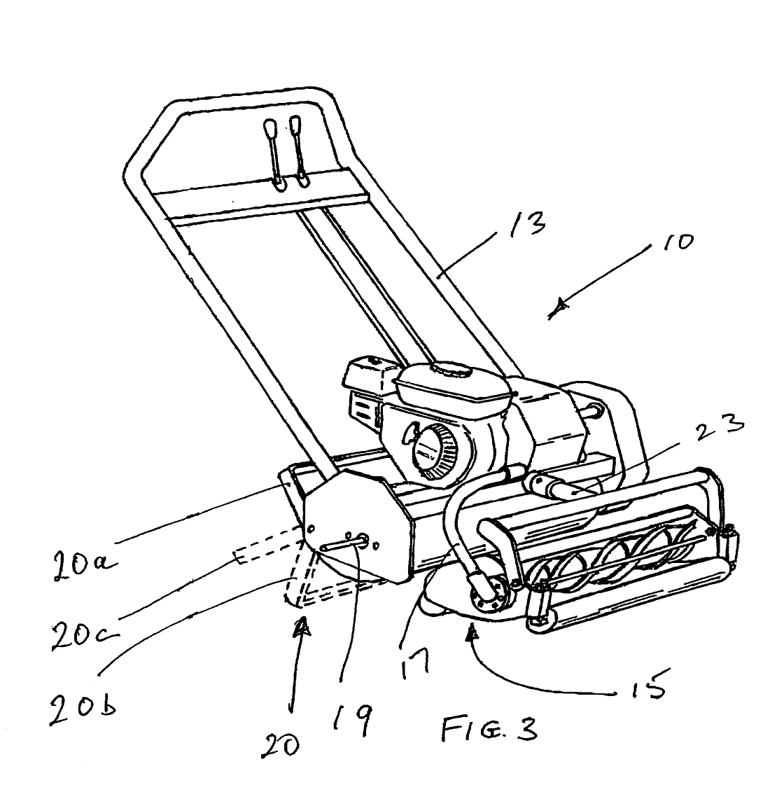

FIG. 2 is a perspective view of the module, of a proprietary type, primarily designed for use with a “ride-on” type multi-unit grass/ground treatment machine; and

FIG. 3 is an assembled view of the power unit and the module.

Referring to the drawing, there is shown a pedestrian-operated power unit according to the invention, and designated generally by reference 10. The unit 10 comprises a chassis 11 and an engine 12 mounted on the chassis 11 and operative to provide motive power to drive the machine over the ground, and also to operate the components of the particular type of grass/ground module which is to be coupled therewith.

The machine 10 has a frame 13 which extends upwardly from the chassis 11 to permit pedestrian control of the operation of the machine via the frame, and has handle 21 and machine controls 22.

An adapter coupling, designated generally by reference 14, is provided on the machine and is adapted to permit releasable mounting thereon of a grass/ground treatment module of a ride-on type machine. As will be well known, ride-on type machines are heavy duty machines, having correspondingly large and expensive treatment modules amounted thereon.

The embodiment of the invention therefore provides a universal type of pedestrian operated power unit, which can have any required proprietary design of treatment module of a ride-on machine mounted thereon when required. The module may comprise a mower unit, scarifier, verticut, or brush unit, of a type provided for use with a Toro or Jacobsen type ride-on machine.

As shown in the drawings, flexible drive shaft 17 may provide transmission of drive derived from the engine 12 and to operate a motor e.g. hydraulic motor via a bevel gearbox 18 connected to one end of a drive shaft of the treatment module. The input end of shaft 17 may be coupled with either one of a pair of engine drive outputs 22, depending upon which side of the module is to be driven.

The drawings illustrate one type of module 15 (for a Jacobson ride-on machine) actually mounted on he unit 10, via a trailing suspension arm 23 pivotally mounted on coupling 14.

The drawing also illustates an adjustable support stand 17 which can take up any one of three adjusted positions to facilitate mounting and de-mounting of the modules, and also for removing transport wheels. The stand 20 can take up a raised, inoperative position, a lowered position suitable for mounting/de-mounting transport wheels (not shown) on axles 19, and an intermediate position permitting mounting/de-mounting of the module (15) on the unit 10.

The illustrated embodiment of the invention therefore provides a pedestrian-operated power unit, to which can be coupled any one of a number of different proprietary grass/ground treatment modules, primarily designed for use with ride-on type triple mowers, e.g. of Jacobsen or Toro manufacture.

The unit is provided with an adaptor coupling (14) to which the treatment module can be mounted or de-mounted, and the illustrated embodiment shows a coupling 14 in the form of a forwardly projecting spigot, on which a trailing suspension arm of the treatment module can be pivotally mounted. The unit of the invention is also provided with one or more drive outputs 22 from which flexible drive shaft 17 can transmit rotary power to operate the treatment module.

The output end of drive shaft 17 has a drive unit 18, and a drive flange has six or more holes to suit modules of different manufacturers, requiring two or four bolt mounting flanges.

In order to adapt the pedestrian unit of the invention to use with different modules of various manufacturers, a range of different adaptor frames may be provided (not shown), to attach the different modules to the “universal” pedestrian power unit of the invention.

The parking stand 20 has three different positions, as shown in FIG. 3. The first position 20a is a raised inoperative position, when the mower is in operation. Position 20b, is a fully lowered position, allowing the fitting or removal of transport drive wheels (not shown) on stub axel 19, and an intermediate or semi-lowered position 20c allows the mower to tip back slightly for fitting or removal of the treatment module.

1. A pedestrian-operated power unit for a detachable grass/ground treatment module, and comprising:
a chassis;
an engine mounted on the chassis;
a frame extending upwardly from the chassis to permit pedestrian control of the unit via the frame; and
an adaptor coupling provided on the unit and adapted to permit releasable mounting thereon of a grass/ground treatment module.

2. A power unit according to claim 1, in which the adaptor coupling is provided on the chassis of the unit.

3. A power unit according to claim 2, in which the adaptor coupling comprises a pivot mounting to which a mounting bar of a detachable module can be connected.

4. A power unit according to claim 3, in which a flexible drive shaft is coupled with a drive output of the engine and is adapted to provide rotary drive input to a drive unit coupled with one end of the treatment module.

5. A power unit according to claim 1, in which the frame is provided with an adjustable support stand.

6. A power unit according to claim 5, in which the support stand is adjustable between a raised inoperative position, a lowered position suitable for removing/attaching transport wheels and an intermediate position to allow attachment/detachment of the module.

7. A power unit according to claim 4, in which the engine has two alternative drive outputs, to which the flexible drive shaft can be coupled, depending upon which side of the treatment module is to receive drive input power.

8. A power unit according to claim 1, in which the frame has a gripping handle by which the unit, and a module detachably mounted thereon, can be manoeuvred.

9. A power unit according to claim 1, in which the treatment module is a proprietary grass/ground treatment device primarily designed for mounting on the frame of a multi-unit ride-on machine.
